(19) United States
(12) Patent Application Publication
(10) Pub. No.: US 2015/0088826 A1
(43) Pub. Date: Mar. 26, 2015

(54) Enhanced Performance for Data Duplication

(71) Applicant: FutureWei Technologies, Inc., Plano, TX (US)

(72) Inventor: Zhexuan Song, Sunnyvale, CA (US)

(73) Assignee: FutureWei Technologies, Inc., Plano, TX (US)

(21) Appl. No.: 14/036,833

(22) Filed: Sep. 25, 2013

(51) Int. Cl. G06F 17/30; G06F 11/14

(52) U.S. Cl. CPC G06F 17/30082; G06F 17/30575; G06F 11/1402
USPC 707/634

(57) ABSTRACT

Systems, methods, computer program products, and apparatuses for enhancing the performance of data duplication are provided. A storage system receives an object, which requires data duplication for increased resiliency. A requisite number of copies of the object are created based on a minimum number defined by a system policy. The storage system stores the object and the requisite number of copies and monitors one or more events in the storage system against predetermined data duplication criteria. The predetermined data duplication criteria are defined within the system policy as criteria for making additional copies of the object over the minimum number. One or more additional copies over the requisite number are created and stored based on the occurrence of the one or more events.

### TECHNICAL FIELD

The present invention relates generally to data storage, and, more specifically, to systems, methods, computer program products, and apparatuses for enhancing the performance of data duplication.

### BACKGROUND

Generally, massive storage systems are used to store large quantities of objects in a network environment (e.g., a cloud). These storage systems are typically designed to handle many billions of objects and tens to hundreds of petabytes of data. These storage systems may be implemented in datacenters, storage pools, or storage clusters. As time passes and storage hardware degrades, the quality of the stored objects may degrade, and the objects may become corrupted.

In order to combat this data corruption, a storage system may store redundant copies of an object in the same or redundant datacenters. When the storage system detects a corrupted object, it may repair the object by, for example, replacing the corrupted object with an uncorrupted copy. As redundancy goes up, the data durability promise (i.e., the reliability) of a storage system increases. Furthermore, increased redundancy may also improve read performance by allowing for parallel readings of multiple copies of an object.

In a typical storage system, a certain requisite number of copies (e.g., three) for each stored object is maintained at all times, for example, to ensure an acceptable reliability level. When disk failure causes certain objects to have fewer than the requisite number of copies, a series of data duplication activities are triggered to replace the missing copies. In order to maintain the system's reliability level, these data duplication activities should be performed immediately. However, as storage system disk size increases, these data duplication activities can be time intensive and require a high percentage of system resources. For example, if a 3 TB disk fails, replicating the data on the disk may take thirty minutes or more. Furthermore, the storage system's performance during this data replication timeframe may suffer due to the replication process's intensive use of system resources (e.g., processing power).

### SUMMARY OF THE INVENTION

These and other problems are generally solved or circumvented, and technical advantages are generally achieved, by preferred embodiments of the present invention which provide enhanced performance for data duplication.

In accordance with an example embodiment, enhanced performance for data duplication may be achieved by creating additional copies of objects in a storage system. For example, a mechanism for data duplication receives an object for data storage and creates a requisite number of copies of the object. The requisite number of copies may be based on a minimum number of data duplication sets defined by a system policy. The mechanism stores the object and the requisite number of copies in the storage system. Furthermore, the mechanism creates and stores an additional copy of the object over the requisite number of copies in accordance with the occurrence of one or more events monitored against predetermined data duplication criteria defined by the system policy.

In accordance with another example embodiment, a mechanism for data duplication stores a plurality of objects in a storage system. A requisite number of copies, based on a minimum number of data duplication sets as defined by a system policy, is maintained for the plurality of objects. The mechanism further stores one or more additional copies over the requisite number of copies for at least some of the plurality of objects in the storage system. The storage of one or more additional copies is in accordance with the occurrence of one or more events monitored against predetermined data duplication criteria also defined by the system policy.

Other embodiments are also disclosed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a storage system in accordance with various example embodiments;

FIG. 2 is a flow diagram of storage system activity to make additional copies in accordance with various example embodiments;

FIG. 3 is a flow diagram of storage system activity when a user updates an object in accordance with various example embodiments;

FIG. 4 is a flow diagram of storage system activity when an object is corrupted in accordance with various example embodiments; and

FIG. 5 is a block diagram illustrating a computing platform that may be used for implementing, for example, the devices and methods described herein, in accordance with an example embodiment.

### DETAILED DESCRIPTION OF ILLUSTRATIVE EMBODIMENTS

Example embodiments covering various aspects of the encompassed innovation are discussed in greater detail below. It should be appreciated, however, that the present invention provides many applicable unique and novel concepts that can be embodied in a wide variety of specific contexts. Accordingly, the specific embodiments discussed herein are merely illustrative of specific ways to make, use, and implement various aspects of the present invention, and do not necessarily limit the scope thereof unless otherwise claimed.

The following example embodiments are described in a specific context, namely a data storage system. As will be appreciated, however, such example embodiments may also be applied to other applications which use redundancy as a mechanism to achieve high reliability.

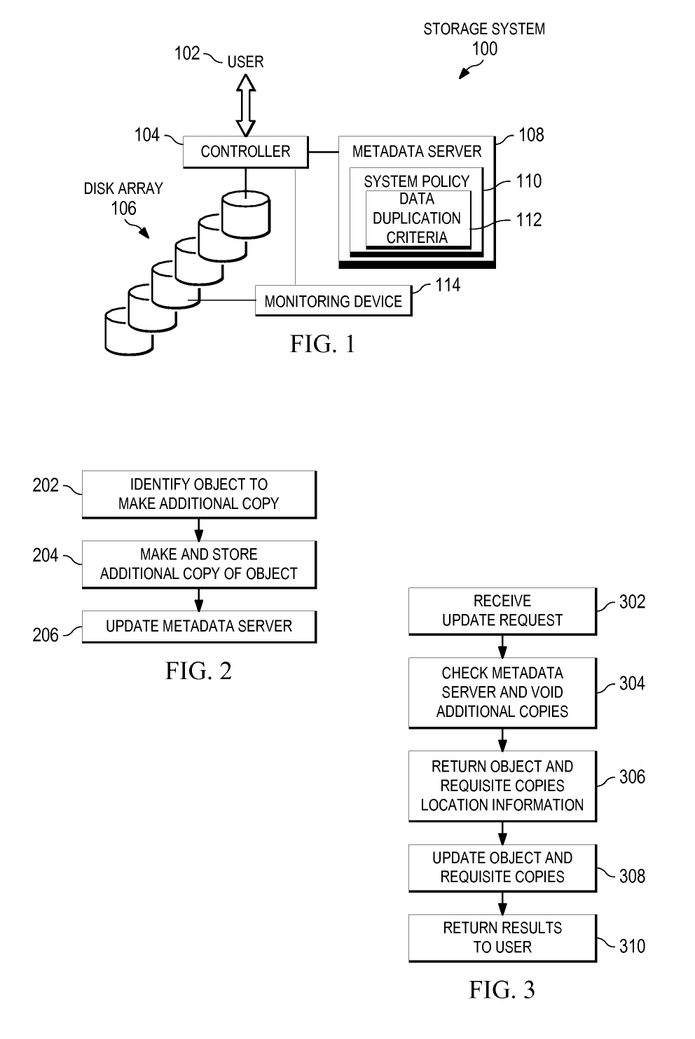

FIG. 1 illustrates a block diagram of a storage system 100 in accordance with various example embodiments. Objects in storage system 100 may be stored a redundant array of independent disks, such as disk array 106, which may use magnetic hard drives, solid state drives, optical drives, or the like. Objects in storage system 100 may also be stored in a column store, a NoSQL database, or another suitable data structure. A user 102 may send objects for storage in storage system 100 over a network, and the objects may require data duplication for increased resiliency. In such embodiments, a controller 104 receives these objects and manages the storage of these objects in disk array 106. Controller 104 may also manage the storage and maintenance of a requisite number of copies for each object to ensure storage system 100 has an acceptable reliability level (i.e., sufficient resiliency) by monitoring various events in storage system 100 against predetermined data duplication criteria 112 defined by a system policy 110. System policy 110 (containing data duplication criteria 112) may be stored in a metadata server 108. Alternatively, system policy 110 and data duplication criteria 112 may be stored elsewhere in storage system 100. Controller 104 may monitor various events in storage system 100 using a monitoring device 114. The various events monitored by monitoring device 114 will be discussed in greater detail in subsequent paragraphs. The number of requisite copies that storage system 100 maintains for each object is generally a minimum number of data duplication sets defined by system policy 110. For example, in storage system 100, system policy 110 may define the minimum number of data duplication sets for each object to be three. Thus, in such embodiments, controller 104, in accordance with the minimum number of data duplication sets defined by system policy 110, may create and store a minimum three copies of each object. The copies of each object may be stored on separate physical disks in disk array 106.

As shown in FIG. 1, controller 104 may use metadata stored on metadata server 108 to track object names, object location, the location of an object's copies, and the like. For example, user 102 may send requests to storage system 100 to perform specific tasks (e.g., to fetch or update an object). To handle such requests, controller 104 decodes and authenticates the request, interacts with metadata server 108 and disk array 106 to perform the desired task, and returns any results to user 102. Of course, other configurations for a storage system, controllers, metadata servers, and disk arrays are contemplated herein; and thus, any specific implementation described herein is used for illustrative purposes only-unless otherwise explicitly claimed.

Typically, a storage system's capacity (i.e., the total amount of storage space) may be significantly greater than the capacity needed to store existing objects and their requisite copies. For example, users often configure storage systems with extra capacity in anticipation of future storage needs. Therefore, a portion of disk array 106 may remain unused and available. In various example embodiments, as part of managing the storage of the object and its copies, additional copies of the objects in storage system 100 (i.e., more than the requisite number of copies) may be stored in these available portions of disk array 106 in accordance with an occurrence of one or more events in the storage system monitored by monitoring device 114 against predetermined data duplication criteria 112 defined within the system policy 110. Unlike the requisite copies, additional copies need not be created immediately (i.e., when storage system 100 receives the object) and may be created at a lower priority level (e.g., when storage system 100 has excess processing resources, storage space, and the like). For example, if three copies of each object in storage system 100 must be maintained for data resiliency, a fourth copy of each object may be created and stored in available portions of disk array 106 when the system has extra resources (e.g., when the system is otherwise idle). Storage system 100 may make one, two, three, or more copies of each object beyond the requisite number depending on, for example, monitoring device 114's detected use of system resources (e.g., storage space in disk array 106, system bandwidth, processing power, and the like) or other events monitored against predetermined data duplication criteria 112 defined within system policy 110 as will be discussed in greater detail below.

In accordance with various example embodiments, predetermined data duplication criteria 112 further include events for replacing corrupted data. For example, when data is corrupted in disk array 106, storage system 100 may immediately restore the requisite number of copies (e.g., three) for each object. However, if an object still has the requisite number of copies in storage system 100 even after data loss (e.g., because an additional fourth copy was stored), immediate duplication may not be necessary. Storage system 100 may create any additional copies over the requisite number of copies based on the occurrence of events monitored by monitoring device 114 compared against predetermined data duplication criteria 112, for example, when the monitoring device 114 detects the system has extra resources (e.g., excess system bandwidth, storage space, processing power, or the like). In an alternative example, storage system 100 may create any additional copies during off-peak hours (e.g., nighttime) because storage system 100 assumes excess system resources may be available during such hours. Therefore, in such embodiments, if an object has an additional copy stored in disk array 106 and one copy is lost (e.g., due to disk failure), no immediate operations may be required by storage system 100 to restore the lost object. Thus, various example embodiments allow for the expenditure of fewer system resources immediately after data loss and allows for the amortization of creating backup copies over time.

Furthermore, as disk array 106 becomes full, storage system 100 may stop making additional backup copies and/or delete any additional copies already on disk array 106 in accordance with events monitored by monitoring device 114 against predetermined data duplication criteria 112 defined by system policy 110. For example, if disk array 106's available storage space falls beneath a first configurable system storage space threshold defined by system policy 110 (e.g., 20% or 10% of the total storage space), then controller 104 may stop creating additional copies of objects. As even more storage space in disk array 106 is used to store objects and requisite copies, controller 104 may start deleting additional copies. For example, if the amount of available storage space falls below a second configurable threshold (e.g., 5%) as defined by system policy 110, then existing additional copies may be deleted.

FIG. 2 illustrates a flow diagram of system operations for making extra copies in accordance with various example embodiments. The process described in FIG. 2 need not occur when a user first sends an object to be stored in storage system 100. Rather, the process in FIG. 2 may occur based on events monitored against predetermined data duplication criteria (e.g., the availability of processing power or storage space) as defined within a system policy. In step 202, a controller (e.g., controller 104) identifies objects to duplicate beyond the requisite number of copies maintained by the system for reliability purposes (e.g., three) as defined by a system policy (e.g., system policy 110). The identification process may be in accordance with the occurrence of events monitored (e.g., by a monitoring device 114) against predetermined data duplication criteria (e.g., data duplication criteria 112) set by the system policy. For example, the predetermined data duplication criteria may relate to system storage space, system bandwidth, system processing power, controller resources (e.g., controller server bandwidth or CPU processing power), time of day (e.g., off-peak activity hours), importance of an object (e.g., important objects, as indicated by a user, may warrant the making of additional copies), or the like. Various thresholds (e.g., system storage space thresholds, system bandwidth thresholds, system processing power thresholds, system controller resource thresholds) may be applied against monitored levels of system resource use, and additional copies may be created and stored over the requisite number of copies based on monitored use of system resources in relation to one or more of these thresholds and/or other criteria. Of course, one of ordinary skill in the art would recognize that other criteria may be used to determine whether to make additional copies, and the examples described here are non-limiting and used for illustrative purposes only-unless otherwise explicitly claimed.

Furthermore, in such embodiments, the predetermined data duplication criteria defined within the system policy may prioritize the making of certain additional copies. For example, the predetermined data duplication criteria may set the controller to prioritize making at least one additional copy over the requisite number of each object in a storage system first before making more additional copies for a particular object. That is, assuming the requisite number of copies in a system is three, the controller may attempt to make four copies for each object in the storage system first before making fifth and sixth copies of an object.

As another example, the predetermined data duplication criteria defined within the system policy may also prioritize making additional copies of objects that have not been updated recently, which is referred to as objects in cold storage. In such scenarios, the system may only make additional copies for objects that have not been modified for at least a certain time period (e.g., 1 hour or 1 day) to prevent making additional copies for objects that are likely to be frequently modified. This prevents the use of unnecessary resources in making additional duplications that are likely to be obsolete in the near future. Generally, the predetermined data duplication criteria defined within the system policy may prioritize making additional copies of objects that are less frequently modified over objects that are frequently updated.

As another example, the predetermined data duplication criteria defined within the system policy may prioritize making additional copies of objects that are frequently queried. Generally, when an object has more copies in the system, each query related to the object may be answered from more sources. Thus having additional copies for an object may improve query efficiency. Of course, one of ordinary skill in the art would recognize that other criteria may be used to prioritize making certain additional copies, and the examples described here are non-limiting and used for illustrative purposes only-unless otherwise explicitly claimed.

In various example embodiments, this priority defined by the system policy, as described above, may be maintained when the controller deletes additional copies, for example, due to the storage system running out of storage space (e.g., when the storage system is more than 95% full). For example, the controller may try and maintain at least one extra copy for each object (i.e., the controller will delete fifth and sixth copies of all the objects before deleting a fourth copy).

In step 204, the controller copies the identified object and manages storage of the additional copy, for example, in a disk array. In step 206, the controller updates any applicable metadata servers (e.g., server 108) with the information about the new copy.

FIG. 3 is a flow diagram illustrating storage system operations when a user (e.g., user 102) updates an object in accordance with various example embodiments. A system policy (e.g., system policy 110) may define in the predetermined data duplication criteria, various events for updating an object. In step 302, the storage system receives a request to update an object from a user. In step 304, the controller (e.g., controller 104) checks the metadata server (e.g., server 108) to locate the object and a requisite number of copies as defined by a system policy. In such embodiments, the controller finds the requisite number of copies (e.g., three) and voids any remaining copies. That is, any additional copies are no longer valid because they will not be updated accordingly in subsequent steps. In step 306, the metadata server returns the locations of the object and the requisite copies. In step 308, the controller updates the object and the requisite copies. Moreover, additional copies may not be updated and are may no longer be associated with the object because the additional copies were voided in step 304. In step 310, the controller returns any results (e.g., a confirmation message) back to the user.

In such embodiments, additional copies may not be immediately updated when a user requests an update. This is due to a likelihood that the object may be modified frequently within the near future. These objects may be referred to as objects in hot storage. For example, a user requesting an update may be working on a file and may request the file be updated again in the near future. If all additional copies were updated in real time, an unnecessary amount of system resources would be expended to make additional duplications over the requisite number. Therefore, various embodiments may only create additional copies of objects in cold storage (i.e., objects that has not been updated in a given time period (e.g., 1 hour or 1 day)).

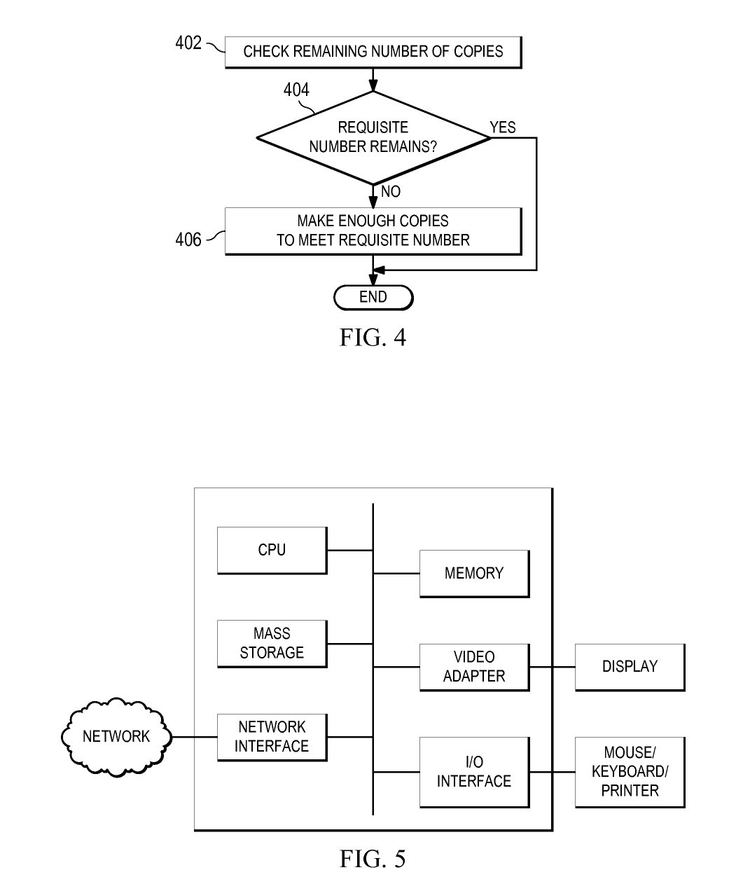

FIG. 4 is a flow diagram illustrating storage system operations when an object is corrupted (e.g., due to disk failure). A system policy (e.g., system policy 110) may define in predetermined data duplication criteria (e.g., data duplication criteria 112), events for replacing corrupted copies. In step 402, a controller (e.g., controller 104) checks the number of remaining copies of the corrupted object. In step 404, the controller determines if the number of remaining copies is less than a requisite number of copies based on a minimum number of data duplication sets as defined by a system policy. If so, then the controller may make as many copies as needed to meet the required number in step 406. If not, the controller does nothing and the process ends. For example, assume the system policy defines the required number of copies for objects in a storage system as three. If an object is corrupted and the controller determines there are only two copies of the object remaining on the storage system, the controller may immediately duplicate the object and stores the copy. However, if the controller determines the storage system still has at least three uncorrupted copies (e.g., because additional copies of the object were made), the controller may do nothing. The controller may make additional copies at a later time in accordance with events monitored (e.g., by a monitoring device 114) against predetermined data duplication criteria set by the system policy. For example, the criteria for making additional copies may include monitoring of system resources against thresholds to determine availability of system resources (e.g., processing power, storage capacity, bandwidth, or the like), controller resources, importance of an object, time of day, or other suitable considerations. The process illustrated by FIG. 4 may be iteratively applied to all corrupted objects in the storage system. Therefore, various example embodiments decrease the amount of system resources that must be immediately expended when an object is corrupted to maintain a requisite number of copies of each object. Thus, the resources expended to create copies of an object may be amortized over time.

FIG. 5 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

I claim:

1. In a storage system, a method for data duplication comprising:
receiving an object for storage, which requires data duplication for increased resiliency;
creating a requisite number of copies of the object as a minimum number of data duplication sets defined by a system policy;
managing storage of the object and the requisite number of copies by monitoring one or more events in the storage system against predetermined data duplication criteria, also defined within the system policy as conditions for performing added data duplication; and
based on an occurrence of the one or more events, creating and managing storage of one or more additional copies of the object over the requisite number of copies.

2. The method of claim 1, wherein the predetermined data duplication criteria defined within the system policy relate to one or more of system storage space, system processing power, system bandwidth, resources of a storage system controller, time of day, and a set level of importance of the object.

3. The method of claim 2, wherein the predetermined data duplication criteria relate to system storage space, and wherein system storage space criteria defines a first predetermined system storage space threshold for when the one or more additional copies are created.

4. The method of claim 3, wherein the first predetermined system storage space threshold is twenty percent of system storage space, wherein the one or more additional copies are not created until available system storage space is at least twenty percent of system storage space.

5. The method of claim 3, wherein after creating the one or more copies, the system storage space criteria defines a second predetermined system storage space threshold for deleting at least one of the one or more additional copies.

6. The method of claim 2, wherein the predetermined data duplication criteria relate to system processing power, and wherein system storage space criteria defines a predetermined system processing power threshold for when the one or more additional copies are created.

7. The method of claim 2, wherein the predetermined data duplication criteria relate to system bandwidth, and wherein system storage space criteria defines a predetermined system bandwidth threshold for when the one or more additional copies are created.

8. The method of claim 2, wherein the predetermined data duplication criteria relate to resources of a storage system controller, and wherein system storage space criteria defines one or more predetermined storage system controller resource thresholds for when the one or more additional copies are created.

9. The method of claim 1, wherein the predetermined data duplication criteria include events for replacing corrupted copies of the requisite number of copies, the method further comprising:
detecting the object or a copy of the object is corrupted;
determining a remaining number of uncorrupted copies of the object on the storage system; and
based on the occurrence of the one or more events, replacing the object or the copy of the object when the remaining number of uncorrupted copies is at least the minimum number of data duplication sets defined by the system policy.

10. The method of claim 1, wherein creating and managing storage of one or more additional copies of the object occur when the object has not been modified within a predetermined time period.

11. The method of claim 10, wherein the predetermined time period is one hour.

12. The method of claim 1, wherein the minimum number of data duplication sets defined by the system policy is three.

13. The method of claim 1, wherein the predetermined data duplication criteria include events for updating the object, the method further comprising, after creating the one or more additional copies:
monitoring receipt of an update request for the object;
updating the object and the requisite number of copies; and
voiding the one or more additional copies, wherein the one or more additional copies are not updated.

14. In a storage system, a method for data duplication comprising:
managing storage of a plurality of objects, which require data duplication for increased resiliency;
maintaining a requisite number of copies for each of the plurality of objects as a minimum number of data duplications sets defined by a system policy by monitoring one or more events in the storage system against predetermined data duplication criteria, also defined within the system policy as conditions for performing added data duplication; and
based on an occurrence of the one or more events, managing storage of one or more additional copies over the requisite number of copies of one or more of the plurality of objects.

15. The method of claim 14, wherein the predetermined data duplication criteria include events for replacing corrupted copies of the requisite number of copies, the method further comprises:
detecting an object or a copy of the object is corrupted, wherein the object is one of the plurality of objects;
determining a remaining number of uncorrupted copies of the object in the storage system; and
when the remaining number of copies is less than the requisite number of copies, creating and managing storage of one or more copies of the object to meet the minimum number of data duplication sets defined by the system policy.

16. The method of claim 15, wherein the method further comprises comprises, when the remaining number of uncorrupted copies is at least the requisite number of copies, based on the occurrence of the one or more events, replacing the object or the copy of the object.

17. The method of claim 14, wherein the predetermined data duplication criteria defined within the system policy relates to one or more of system storage space, system processing power, system bandwidth, resources of a storage system controller, time of day, and a set level of importance of the object.

18. The method of claim 14, wherein the predetermined data duplication criteria as defined within the system policy prioritizes storing a first additional copy of each of the plurality of objects before storing a second additional copy of one of the plurality of objects.

19. The method of claim 14, wherein the predetermined data duplication criteria as defined within the system policy prioritizes storing one or more additional copies of less frequently modified objects.

20. The method of claim 14, wherein the predetermined data duplication criteria as defined within the system policy prioritizes storing one or more additional copies of more frequently queried objects.

21. A computer-programmable product comprising computer executable instructions stored on a non-transitory computer readable storage medium, such that when executed by a computer processor cause it to perform the following:
receive an object for storage in a storage system, which requires data duplication for increased resiliency;
create a requisite number of copies of the object as a minimum number of data duplication sets defined by a system policy;
manage storage of the object and the requisite number of copies by monitoring one or more events in the storage system against predetermined data duplication criteria, also defined with the system policy as conditions for performing added data duplication; and
based on an occurrence of the one or more events, create and manage storage of one or more additional copies of the object over the requisite number of copies.

22. The computer-programmable product of claim 21, wherein the predetermined data duplication criteria include events for replacing corrupted copies of the requisite number of copies, and wherein the computer executable instructions further cause the computer-programmable product to:
detect the object or a copy of the object is corrupted;
determine a remaining number of uncorrupted copies of the object; and
based on the occurrence of the one or more events, replace the object or the copy of the object when the remaining number of copies is at least the requisite number of copies.

23. The computer-programmable product of claim 21, the predetermined data duplication criteria defined within the system policy relates to one or more of system storage space, system processing power, system bandwidth, resources of a storage system controller, time of day, and a set level of importance of the object.
